(19) United States
(12) Patent Application Publication
(10) Pub. No.: US 2026/0037266 A1
(43) Pub. Date: Feb. 5, 2026

(54) PROCESSOR WITH SECURE BRANCH PREDICTION FUNCTION AND SECURE BRANCH PREDICTION METHOD

(71) Applicant: NATIONAL CHENG KUNG UNIVERSITY, Tainan City (TW)

(72) Inventors: Lih-Yih CHIOU, Tainan City (TW); Shih-Ying TENG, Hsinchu City (TW); Wen-Yen PENG, Miaoli County (TW)

(21) Appl. No.: 18/963,825

(22) Filed: Nov. 29, 2024

(30) Foreign Application Priority Data
Aug. 2, 2024 (TW) 113128861

(51) Int. Cl. G06F 9/38; G06F 9/30; G06F 9/32

(52) U.S. Cl. CPC G06F 9/3844; G06F 9/3005; G06F 9/321; G06F 9/3806; G06F 21/556

(57) ABSTRACT

A processor with secure branch prediction function includes a counter, a user core circuit and a secure branch prediction circuit. The counter is configured to generate a plurality of task identifications, wherein the task identifications include a current task identification and a previous branch task identification. The user core circuit is configured to execute an operating system, and request the operating system to assign the current task identification to a current task while the current task is created. The secure branch prediction circuit is configured to compare the current task identification with the previous branch task identification to generate a comparison result while the current task performs branch prediction of a branch instruction, and output a jump prediction message or a non-jump prediction message based on the comparison result.

### RELATED APPLICATIONS

This application claims priority to Taiwan Application Serial Number 113128861, filed on Aug. 2, 2024, which is herein incorporated by reference.

### BACKGROUND

### Technical Field

The present disclosure relates to a branch prediction technology, and more particular to a processor with secure branch prediction function and secure branch prediction method.

### Description of Related Art

In recent years, with the increasing number of real-time smart applications, the Internet of Things (IoT) combined with artificial intelligence (AI) has created a trend of new applications. Smart IoT devices do not need to be connected back to the server. Instead, the sensing data is predicted and even self-optimized locally through the designed artificial intelligence model, which is the category of edge computing. In order to enable IoT devices to perform higher-performance edge computing, the processor speed may be optimized through branch prediction. Otherwise, the execution of branch instructions often needs to wait for the jump result to be determined, which will cause waiting time of the pipeline processor, thereby reducing performance. In order to avoid wasting waiting cycles caused by branch instructions, branch instruction prediction can first guess the control flow direction and execute the instruction in the guessed direction first. If the jump result is the same as the prediction result, the waiting time may be successfully hidden. Although it has become common to use a branch predictor to hide the waiting time required by the processor to calculate the result of the jump result, malicious attackers may steal confidential information of smart IoT devices through branch side-channel attacks, and even affect the operational behavior of device users, thereby increasing attack vulnerabilities, causing the risk of leaking private information and even causing personal and property losses.

### SUMMARY

The object of the present disclosure is to provide a processor with secure branch prediction function and a secure branch prediction method. Through assigning each task an individual task identification and designing each row in the pattern history table to be task independent, so that different tasks may not access each other's branch status history, so as to achieve the effect of resisting branch prediction attacks.

One aspect of the present disclosure relates to a processor with secure branch prediction function, which includes a counter, a user core circuit, and a secure branch prediction circuit. The counter is configured to generate a plurality of task identifications (TIDs), in which the task identifications comprise a current task identification and a previous branch task identification. The user core circuit is configured to execute an operating system, and request the operating system to assign the current task identification to a current task while the current task is created. The secure branch prediction circuit is configured to compare the current task identification with the previous branch task identification to generate a comparison result while the current task performs branch prediction of a branch instruction, and output a jump prediction message or a non-jump prediction message based on the comparison result.

In accordance with one or more embodiments of the present disclosure, the secure branch prediction circuit is further configured to access a pattern history table (PHT) to obtain a branch status and access a branch target buffer (BTB) to obtain an execution target address while the comparison result indicates that the current task identification is the same as the previous branch task identification.

In accordance with one or more embodiments of the present disclosure, the secure branch prediction circuit is further configured to output the jump prediction message after accessing the branch status and the execution target address.

In accordance with one or more embodiments of the present disclosure, the secure branch prediction circuit is further configured to flush the pattern history table and the branch target buffer while the comparison result indicates that the current task identification is different from the previous branch task identification.

In accordance with one or more embodiments of the present disclosure, the secure branch prediction circuit is further configured to output the non-jump prediction message after flushing the pattern history table and the branch target buffer.

In accordance with one or more embodiments of the present disclosure, the processor is simulated by a cycle-accurate electronic system level (ESL) platform.

In accordance with one or more embodiments of the present disclosure, the secure branch prediction circuit is designed utilizing a gshare-style 2-level predictor.

In accordance with one or more embodiments of the present disclosure, the operating system is a FreeRTOS operating system.

Another aspect of the present disclosure relates to a secure branch prediction method, which includes executing an operating system by a user core circuit to request the operating system to assign a current task identification to a current task while the current task is created; comparing the current task identification with a previous branch task identification to generate a comparison result by a secure branch prediction circuit while the current task performs branch prediction of a branch instruction; and outputting a jump prediction message or a non-jump prediction message by the secure branch prediction circuit based on the comparison result.

In accordance with one or more embodiments of the present disclosure, the secure branch prediction circuit is further configured to access a pattern history table (PHT) to obtain a branch status and access a branch target buffer (BTB) to obtain an execution target address while the comparison result indicates that the current task identification is the same as the previous branch task identification.

In accordance with one or more embodiments of the present disclosure, the secure branch prediction circuit is further configured to output the jump prediction message after accessing the branch status and the execution target address.

In accordance with one or more embodiments of the present disclosure, the secure branch prediction circuit is further configured to flush the pattern history table and the branch target buffer while the comparison result indicates that the current task identification is different from the previous branch task identification.

In accordance with one or more embodiments of the present disclosure, the secure branch prediction circuit is further configured to output the non-jump prediction message after flushing the pattern history table and the branch target buffer.

In accordance with one or more embodiments of the present disclosure, the secure branch prediction circuit is designed utilizing a gshare-style 2-level predictor.

In accordance with one or more embodiments of the present disclosure, the operating system is a FreeRTOS operating system.

### BRIEF DESCRIPTION OF THE DRAWINGS

This disclosure can be more fully understood by reading the following detailed description of the embodiments, with reference made to the accompanying drawings as follows.

FIG. 1 is a schematic diagram of system architecture of a secure branch prediction circuit simulated by a cycle-accurate electronic system level platform in accordance with some embodiments of the present disclosure.

FIG. 2 is a schematic diagram of task identification in accordance with some embodiments of the present disclosure.

FIG. 3 is a flowchart of a secure branch prediction method in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts.

The terms utilized in this disclosure are only for describing specific embodiments and are not intended to limit the scope of the claim. Unless otherwise restricted, the singular form “a” or “the” may also be utilized to denote the plural form.

With the development of Internet of Things (IoT) applications, branch predictors are widely utilized in high-performance edge computing devices, but thereby increasing the risk of attacks for the entire system. For malicious attackers, the purpose is to make the processor execute the wrong prediction direction, thereby stealing the confidential information of the victim or causing the system to output unexpected results. For system designers, once the system is cracked, it will cause the confidential information of the user to be leaked, which may result in loss of money and goodwill.

In order to prevent branch prediction attacks, a common defense method is to allow the confidential information to be accessed in an isolated environment. Isolation methods may be divided into hardware isolation methods and software isolation methods. The software isolation methods include automatically generating indirect jump instructions based on the confidential information, or inserting special instructions to slow down hidden channel attacks on privileged programs. However, in addition to requiring the redesign of customized instructions, the above protection may not completely prevent the leakage of the confidential information in the runtime system.

On the other hand, the hardware isolation methods may be divided into three types. One is flushing the pattern history table (PHT) and branch target buffer (BTB) during context switch. Although this type of the hardware isolation methods may greatly reduce the hardware burden. However, since the entire pattern history table needs to be flushed every time while a context switch occurs, the branch prediction accuracy decreases, and the pattern history table needs to be retrained, thereby resulting in performance degradation. The second type of the hardware isolation methods is to copy multiple independent branch predictors to separate branch histories of different programs. However, since the branch histories of the multiple programs need to be stored, the hardware cost is still considerable. The third type of the hardware isolation methods is to randomize the index of the branch instruction predictor and encrypt the historical content. However, this protection method may only prevent some Specter attacks such as Specter V2 and Specter-RSB, and has no significant effect on other side-channel attacks.

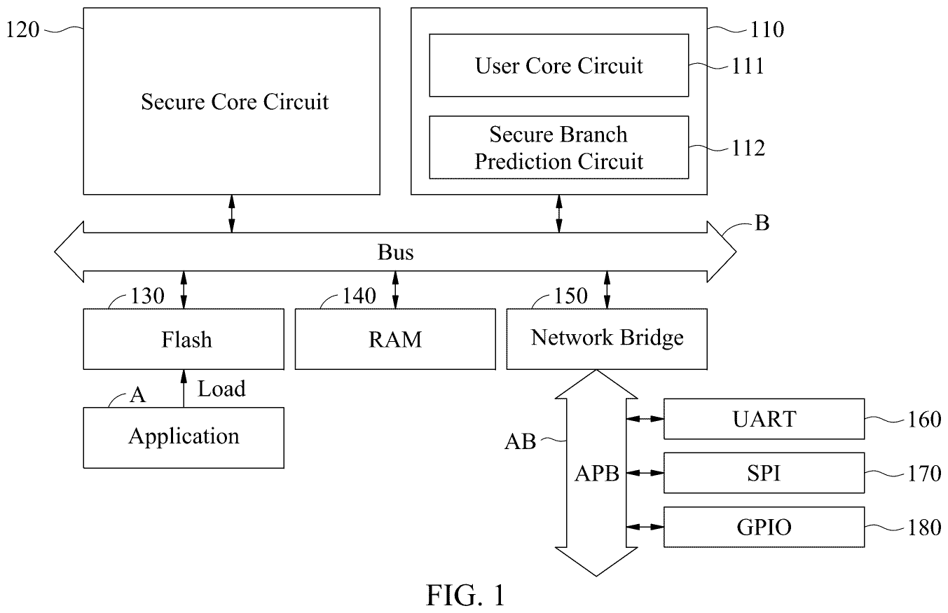

FIG. 1 is a schematic diagram of a system architecture of a secure branch prediction circuit simulated by a cycle-accurate electronic system level (ESL) platform in accordance with some embodiments of the present disclosure. In one embodiment of the present disclosure, the operation of a processor 110 with secure branch prediction function is simulated by a cycle-accurate electronic system level platform. The platform has two microprocessor cores, a 64-bit user core circuit 111 and a 32-bit secure core circuit 120, respectively. The 64-bit user core circuit 111 is modified from an open source code ARA and configured to execute an operating system or an application A. The secure branch prediction circuit 112 is designed and protected utilizing a gshare-style 2-level predictor that is relatively common in today's processors. The operating system may utilize a FreeRTOS operating system, which is a real-time operating system suitable for embedded systems, and makes small and performance-optimized edge devices easier to program, deploy, and manage. The 32-bit secure core circuit is configured for secure programming and verification processes. The bus B is a bus matrix composed of Advanced extensible Interface (AXI) buses. The flash 130 is configured to store instructions that need to be executed. The random-access memory (RAM) 140 is configured to store computing data. The network bridge 150 is configured to electrically connect the bus B (which may be, for example, an advanced high-performance bus (AHB)) and an advanced peripheral bus (APB) AB. Further, the advanced peripheral bus AB includes a universal asynchronous receiver/transmitter (UART) 160, a serial peripheral interface bus (SPI) 170, and a general-purpose input/output (GPIO) 180 configured to communicate with the outside of the platform.

In the processor 110 with secure branch prediction function utilizing the FreeRTOS operating system as shown in FIG. 1, the executed program is called a task. By numbering each task, different tasks have their own independent numbers, that is, each task has an individual task identification (TID). It should be noted that the kernel code of the FreeRTOS operating system has a process control block (PCB) like other operating systems, which is called a task control block (TCB).

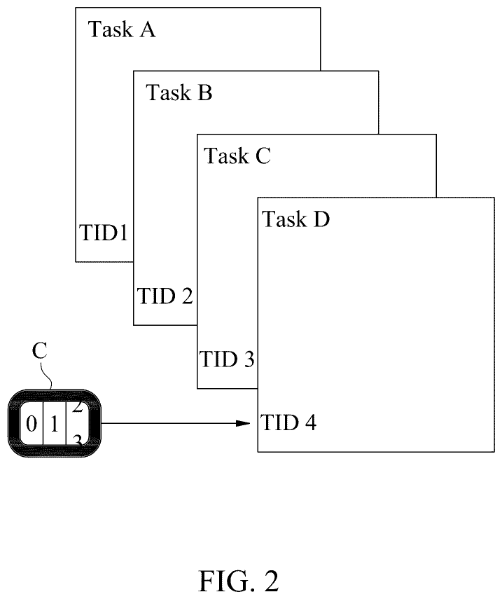

FIG. 2 is a schematic diagram of task identification in accordance with some embodiments of the present disclosure. Whenever a new task is created, the user core circuit 111 requests the FreeRTOS operating system to assign a task identification to the new task. In specific, the kernel code of the FreeRTOS operating system generates a new task control block to specifically record the information of the new task. After generating the task control block corresponding to the new task, through designing the kernel code of the FreeRTOS operating system, a task identity code parameter is added to the task control block. The task identification parameter is numbered through the counter C (not shown in FIG. 1) in the processor 110. The value of the current counter C is written into the task identification while the new task is created, and the value of the counter C is increased by 1, and then continues to wait for the next new task to be created.

Taking the schematic diagram of the task identification shown in FIG. 2 as an example, the kernel code of the FreeRTOS operating system generates a new task control block to record the information of Task A while Task A is created, and writes the current value of the counter C into the task identification in the task control block, that is, writes the task identification TID1 into the task control block of Task A, and the value of the counter C is increased by 1, and then continues to wait for the next new task (such as Task B shown in FIG. 2) to be created. Similarly, the kernel code of the FreeRTOS operating system generates task control blocks to record the information of Task B, Task C, and Task D, respectively, while Task B, Task C, and Task D are created, and writes the task identification TID2 into the task control block of Task B, writes the task identification TID3 into the task control block of Task C, and writes the task identification TID4 into the task control block of Task D. If a new task is created after Task D in the future, the operation of the FreeRTOS operating system writing the task identification into the task control block may be deduced in the same way.

While a context switch occurs, which means that the processor 110 needs to switch execution between different tasks due to a new task is created. First, the task identification of the new task is written into an internal register, called current ID buffer, through the kernel code of the designed FreeRTOS operating system. It should be noted that the current ID buffer can only be written with the task identification while the key owned by the new task is correct, so as to prevent the current ID buffer from being tampered with by illegal programs.

The processor 110 with secure branch prediction function further includes the secure branch prediction circuit 112. The secure branch prediction circuit 112 is configured to design each row (e.g. table entry) in the pattern history table to be task independent, which means that different tasks may not access each other's branch status history, so as to achieve the effect of resisting branch prediction attacks. While there is a new branch instruction to perform branch prediction, the secure branch prediction circuit 112 compares the current task identification of the new task stored in the current ID buffer with the previous branch task identification of the previous branch task, and corresponding operations are performed on the pattern history table and the branch target buffer based on the comparison result.

After comparing the current task identification of the new task stored in the current ID buffer with the previous branch task identification in the pattern history table, if the comparison result of the two task identification is the same, the secure branch prediction circuit 112 accesses the pattern history table to obtain a branch status, and accesses the branch target buffer to obtain an execution target address. By confirming that the comparison result between the current task identification and the previous branch task identification is the same, it ensures that while multiple tasks share the same pattern history table, the task utilizing the pattern history table is the same task, so as to achieve the purpose of resisting branch prediction attacks.

After obtaining the branch status of the pattern history table and the execution target address of the branch target buffer, the secure branch prediction circuit 112 outputs a jump prediction message, which means that the prediction result of the branch instruction is taken, and the processor 100 then jumps to the execution target address to execute the branch instruction.

After comparing the current task identification of the new task stored in the current ID buffer with the previous branch task identification in the pattern history table, if the comparison result of the two task identification is different, the secure branch prediction circuit 112 flushes the pattern history table and the execution target address of the branch target buffer, and the secure branch prediction circuit 112 outputs a non-jump prediction message, which means that the prediction result of the branch instruction is not taken. Meanwhile, the execution target address of the branch target buffer is set to zero.

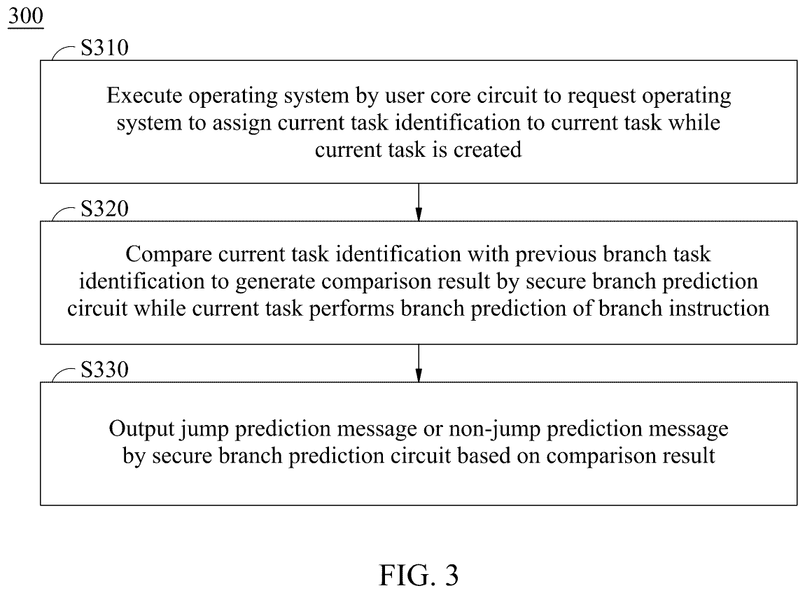

FIG. 3 is a flowchart of a secure branch prediction method in accordance with some embodiments of the present disclosure. The following paragraphs describe the implementation method of each step in conjunction with FIGS. 1-3. The secure branch prediction method 300 includes steps S310 to S330 described below.

Step S310: Execute operating system by user core circuit to request operating system to assign current task identification to current task while current task is created. This step is to disclose that whenever a new task is created, the user core circuit (such as user core circuit 111 shown is FIG. 1) requests the operating system (such as FreeRTOS operating system) to assign a task identification to the new task. In specific, the kernel code of the operating system generates a new task control block to specifically record the information of the new task. After generating the task control block corresponding to the new task, through designing the kernel code of the operating system, a task identity code parameter is added to the task control block. The task identification parameter is numbered through the counter (such as counter C shown in FIG. 2). The value of the current counter is written into the task identification while the new task is created, and the value of the counter is increased by 1, and then continues to wait for the next new task to be created.

Taking the schematic diagram of the task identification shown in FIG. 2 as an example, the kernel code of the operating system generates a new task control block to record the information of Task A while Task A is created, and writes the current value of the counter C into the task identification in the task control block, that is, writes the task identification TID1 into the task control block of Task A, and the value of the counter C is increased by 1, and then continues to wait for the next new task (such as Task B shown in FIG. 2) to be created. Similarly, the kernel code of the operating system generates task control blocks to record the information of Task B, Task C, and Task D, respectively, while Task B, Task C, and Task D are created, and writes the task identification TID2 into the task control block of Task B, writes the task identification TID3 into the task control block of Task C, and writes the task identification TID4 into the task control block of Task D. If a new task is created after Task D in the future, the operation of the operating system writing the task identification into the task control block may be deduced in the same way.

In one embodiment of the present disclosure, while a context switch occurs, first, the task identification of the new task is written into an internal register, called current ID buffer, through the kernel code of the designed FreeRTOS operating system. It should be noted that the current ID buffer can only be written with the task identification while the key owned by the new task is correct, so as to prevent the current ID buffer from being tampered with by illegal programs.

Step S320: Compare current task identification with previous branch task identification to generate comparison result by secure branch prediction circuit while current task performs branch prediction of branch instruction. This step is to disclose that the secure branch prediction circuit (such as secure branch prediction circuit 112 shown in FIG. 1) is configured to design each row in the pattern history table to be task independent, which means that different tasks may not access each other's branch status history, so as to achieve the effect of resisting branch prediction attacks. While there is a new branch instruction to perform branch prediction, the secure branch prediction circuit 112 compares the current task identification of the new task stored in the current ID buffer with the previous branch task identification of the previous branch task, and corresponding operations are performed on the pattern history table and the branch target buffer based on the comparison result.

Step S330: Output jump prediction message or non-jump prediction message by secure branch prediction circuit based on comparison result. This step is to disclose that after comparing the current task identification of the new task stored in the current ID buffer with the previous branch task identification in the pattern history table, if the comparison result of the two task identification is the same, the secure branch prediction circuit 112 accesses the pattern history table to obtain a branch status, and accesses the branch target buffer to obtain an execution target address. By confirming that the comparison result between the current task identification and the previous branch task identification is the same, it ensures that while multiple tasks share the same pattern history table, the task utilizing the pattern history table is the same task, so as to achieve the purpose of resisting branch prediction attacks.

After obtaining the branch status of the pattern history table and the execution target address of the branch target buffer, the secure branch prediction circuit outputs a jump prediction message, which means that the prediction result of the branch instruction is taken, and the processor (such as processor 110 shown in FIG. 1) then jumps to the execution target address to execute the branch instruction.

After comparing the current task identification of the new task stored in the current ID buffer with the previous branch task identification in the pattern history table, if the comparison result of the two task identification is different, the secure branch prediction circuit flushes the pattern history table and the execution target address of the branch target buffer, and the secure branch prediction circuit outputs a non-jump prediction message, which means that the prediction result of the branch instruction is not taken. Meanwhile, the execution target address of the branch target buffer is set to zero.

In some embodiments, while there are too many tasks to be executed, the tasks may compete with each other for limited hardware resources, resulting in too frequent input/output (I/O) between the memory and the disk, thereby dragging down the performance of the processor. Therefore, although the FreeRTOS operating system does not limit the number of tasks to be executed, the number of tasks in a microprocessor system with immediate needs should still be limited.

In order to implement the secure branch prediction method in operating systems that are more complex than FreeRTOS (such as Linux, Window or MacOS), a branch mapping table (BMT) may be designed to deal with possible situations where tasks compete with each other for limited hardware resources. In Specific, while multiple tasks are going to access the same branch prediction address, the designed branch mapping table may be utilized to confirm the task identification of the task currently occupying this row in the branch pattern history table, and then determines whether the previous history of this row in the pattern history table can be flushed and occupy this row in the pattern history table based on the priority of different tasks.

In summary, the processor with secure branch prediction function and the secure branch prediction method of the present disclosure assign each task an individual task identification and design each row in the pattern history table to be task independent, so that different tasks may not access each other's branch status history, so as to achieve the effect of resisting branch prediction attacks.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. A processor with secure branch prediction function, comprising:
a counter configured to generate a plurality of task identifications (TIDs), wherein the task identifications comprise a current task identification and a previous branch task identification;
a user core circuit configured to execute an operating system, and request the operating system to assign the current task identification to a current task while the current task is created; and
a secure branch prediction circuit configured to compare the current task identification with the previous branch task identification to generate a comparison result while the current task performs branch prediction of a branch instruction, and output a jump prediction message or a non-jump prediction message based on the comparison result.

2. The processor of claim 1, wherein the secure branch prediction circuit is further configured to access a pattern history table (PHT) to obtain a branch status and access a branch target buffer (BTB) to obtain an execution target address while the comparison result indicates that the current task identification is the same as the previous branch task identification.

3. The processor of claim 2, wherein the secure branch prediction circuit is further configured to output the jump prediction message after accessing the branch status and the execution target address.

4. The processor of claim 2, wherein the secure branch prediction circuit is further configured to flush the pattern history table and the branch target buffer while the comparison result indicates that the current task identification is different from the previous branch task identification.

5. The processor of claim 4, wherein the secure branch prediction circuit is further configured to output the non-jump prediction message after flushing the pattern history table and the branch target buffer.

6. The processor of claim 1, wherein the processor is simulated by a cycle-accurate electronic system level (ESL) platform.

7. The processor of claim 1, wherein the secure branch prediction circuit is designed utilizing a gshare-style 2-level predictor.

8. The processor of claim 1, wherein the operating system is a FreeRTOS operating system.

9. A secure branch prediction method, comprising:
executing an operating system by a user core circuit to request the operating system to assign a current task identification to a current task while the current task is created;
comparing the current task identification with a previous branch task identification to generate a comparison result by a secure branch prediction circuit while the current task performs branch prediction of a branch instruction; and
outputting a jump prediction message or a non-jump prediction message by the secure branch prediction circuit based on the comparison result.

10. The method of claim 9, wherein the secure branch prediction circuit is further configured to access a pattern history table (PHT) to obtain a branch status and access a branch target buffer (BTB) to obtain an execution target address while the comparison result indicates that the current task identification is the same as the previous branch task identification.

11. The method of claim 10, wherein the secure branch prediction circuit is further configured to output the jump prediction message after accessing the branch status and the execution target address.

12. The method of claim 10, wherein the secure branch prediction circuit is further configured to flush the pattern history table and the branch target buffer while the comparison result indicates that the current task identification is different from the previous branch task identification.

13. The method of claim 12, wherein the secure branch prediction circuit is further configured to output the non-jump prediction message after flushing the pattern history table and the branch target buffer.

14. The method of claim 9, wherein the secure branch prediction circuit is designed utilizing a gshare-style 2-level predictor.

15. The method of claim 9, wherein the operating system is a FreeRTOS operating system.
